(19) United States
(12) Patent Application Publication
(10) Pub. No.: US 2008/0310835 A1
(43) Pub. Date: Dec. 18, 2008

(54) SYSTEM FOR VALIDATING INSTALLATION OF OPTICAL NETWORK DEVICES

(75) Inventors: JULIE D. LORENTZEN, PLEASANTON, CA (US); EUGENE L. EDMON, DANVILLE, CA (US); GOANGSHIUAN S. YING, OAKLAND, CA (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/764,601

(22) Filed: Jun. 18, 2007

(51) Int. Cl. H04B 10/08

(52) U.S. Cl. 398/9

(57) ABSTRACT

A system for validating installation of optical network devices is disclosed. A system that incorporates teachings of the present disclosure may include, for example, an optical network device (OND) having a controller element to receive a work order from a monitoring device coupled to the OND, transmit the work order and identification data to an optical management device (OMD), receive an installation status report from the OMD based on a comparison of the identification data and validation data retrieved according to the work order, and transmit the installation status report to the monitoring device. Additional embodiments are disclosed.

### FIELD OF THE DISCLOSURE

The present disclosure relates generally to network installation techniques, and more specifically to a system for validating installation of optical network devices.

### BACKGROUND

National deployment of fiber to the curb or premise (FTTC, FTTP) is a costly investment for telecommunication companies. Consequently, any process that streamlines the installation of optical network elements such as an optical network unit (ONU) or optical network terminal (ONT) is desirable.

Presently, when a field technician installs an ONU or ONT the technician may not readily have practical means to confirm that the correct type of ONU or ONT has been installed in a select site. Moreover, an installation of an incorrect ONU or ONT may not be detected until well after the technician leaves the installation site.

A need therefore arises for a system for validating installation of optical network devices.

### BRIEF DESCRIPTION OF THE DRAWINGS

FIG. 1 depicts an exemplary embodiment of a portion of a Gigabit passive optical network (GPON) communication system;

FIG. 2 depicts an exemplary method operating in portions of the GPON communication system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system for validating installation of optical network devices.

In an embodiment of the present disclosure, an optical network device (OND) corresponding to one among an optical network unit (ONU) and an optical network terminal (ONT) can have a controller element to receive a work order from a butt set coupled to the OND, transmit the work order and identification data to an optical management device (OMD), receive an installation status report from the OMD based on a comparison of the identification data and validation data retrieved according to the work order, and transmit the installation status report to the butt set.

In another embodiment of the present disclosure, a computer-readable storage medium can have computer instructions for receiving a work order and identification data from an OND, retrieving validation data according to the work order, comparing the validation data with the identification data to determine whether the OND was installed properly in an optical communication network.

In another embodiment of the present disclosure, a monitoring device can have a controller element to transmit a work order to an OND coupled to the monitoring device during an installation of the OND, and receive an installation status report from the OND responsive to comparing identification data of the OND and validation data retrieved according to the work order.

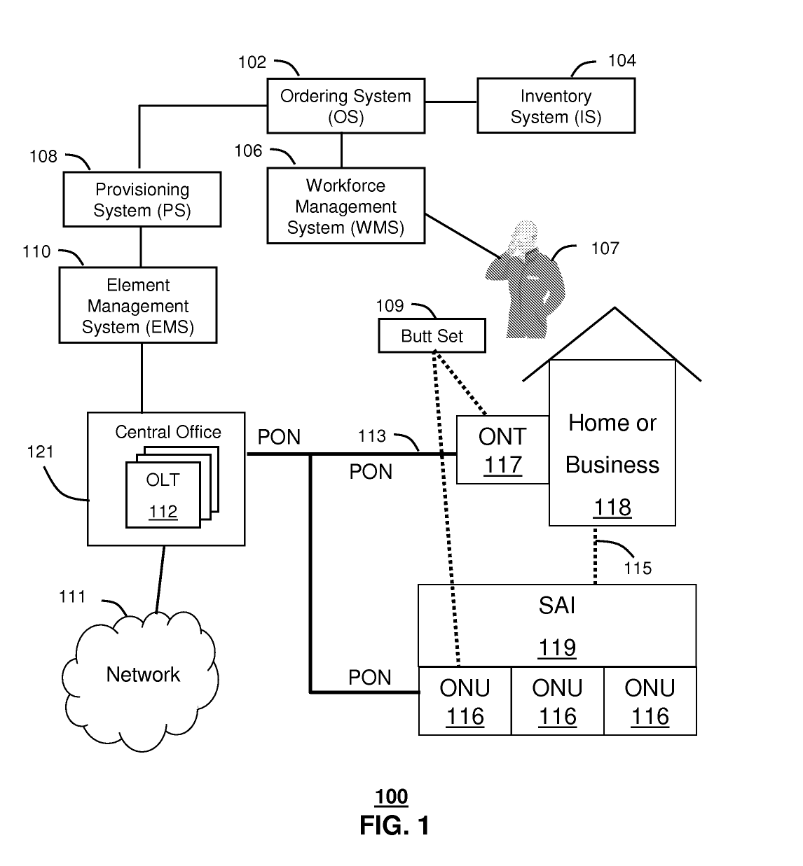

FIG. 1 depicts an exemplary embodiment of a portion of a Gigabit Passive Optical Network (GPON) communication system 100. The GPON communication system 100 comprises one or more Optical Line Terminations (OLTs) 112 coupled to one or more optical network devices (ONDs) such as an Optical Network Unit (ONUs) 116 or optical network terminal (ONT) 117. The OLT 112 generally resides in a central office or cable company head end. The ONU 116 provides optical to electrical and electrical to optical conversion between the fiber and the copper wires 115 that reach homes and offices in a “fiber to the curb” (FTTC) or “fiber to the neighborhood” (FTTN) deployments. When the optical line is connected directly into a residence or business as “fiber to the premises” (FTTP), an ONT 117 is used to terminate the fiber. The OLT 112, ONUs 116 and ONTs 117 can operate according to a GPON Transmission Convergence (GTC) protocol and can utilize common computing and communications technology for routing digital traffic between end points of the GPON communication system 100.

The PON communication system 100 can also include an ordering system (OS) 102 to issue or receive service orders, an Inventory System (IS) 104 communicatively coupled to the OS 102 to associate an ONU 116 with an SAI 119 or an ONT 117 to a home or residence 118, a Provisioning System (PS) 108 communicatively coupled to the OS 102 for provisioning an installation or maintenance of the ONU 116 and ONT 117, an Element Management System (EMS) 110 communicatively coupled to the PS 108 for activating the PON connection 113 to the ONU 116 or ONT 117, and a network 111 coupled to the central office 112 for augmenting the communication coverage of the GPON network 100.

The PON communication system 100 can include a workforce management system 106 (WMS) to receive service orders from the OS 102, and dispatch ONU and OLT work requests to one or more field technicians 107 to install or service an ONU 116 in an SAI 119 or ONT 117 at a residence or business 118. The field technician can use a monitoring device such as a butt-set 109 to communicate with the ONU 116 or ONT 117 during installation, maintenance or repair. The butt-set 109 can be used to enter a registration number for validating installation of an ONU 116 or ONT 117. The registration number is generated by the OS 102 in association with the work order issued by the WMS 106.

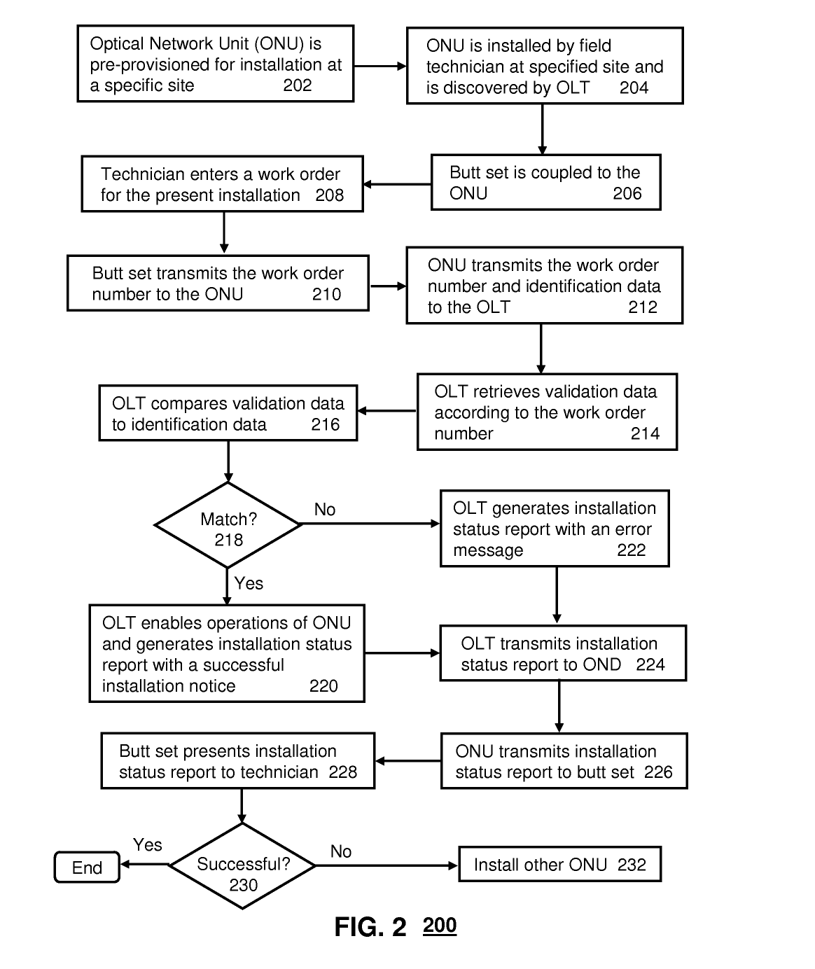

FIG. 2 depicts an exemplary method 200 operating in portions of the GPON communication system 100. Method 200 describes a process for validating an installation of an ONU 116 or ONT 117. The validation process can take place in part in an OLT 112 or an EMS 110 which singly or in combination can serve as an optical management device (OMD). For illustration purposes, method 200 describes the installation of an ONU 116 utilizing the OLT 112 as a point of validation. It will be appreciated by an artisan of ordinary skill in the art that method 200 can be adapted for validating installation of an ONT 117 as well, and the validation process can take place instead in the EMS 110 or a combination of the EMS and OLT.

With these principles in mind, method 200 begins with step 202 where an ONU 116 is pre-provisioned for installation at a specific site. When the ONU 116 is installed by a field technician at the specified site in step 204, the ONU can be discovered by the OLT 112 using common means defined in the GPON protocol. In step 206, the technician couples the butt set 109 to the ONU 116 by cable or a wireless interface (e.g., Bluetooth), and enters a work order number into the butt set using a common keypad or touch-screen. The work order number can represent a registration number or some other suitable form of identification that can be associated with the installation of the ONU 116. Alternatively, the butt set 109 can be coupled to the ONU 112 before the ONU 116 is fully installed or discovered by the OLT 112.

Once the work order number has been entered, the butt set 107 transmits it to the ONU 116. The ONU 116 in turn transmits to the OLT 112 in step 212 the work order number and identification data associated with the ONU. The identification data can comprise, for example, a vendor ID, a model number, and/or a serial number of the ONU 116. Other suitable forms of identification can be used to identify the type of ONU 116 installed. In step 214, the OLT 112 retrieves validation data according to the work order number. The retrieval can take place from a local database operating in the OLT 112 or from other systems in the GPON network 100 such as the EMS 110, the IS 104 or WMS 106. The work order can be used as an index to search through the database of any of these systems. The validation data can include a vendor ID, model number and/or serial number that identifies a proper ONU type to install in the specified site. The validation data can be created at the time the OS 102 generated the service order which is recorded by the IS 104 in the OLT 112 or some other network management element of the GPON network 100.

Once validation data is retrieved, in step 216 the OLT 112 compares it to the identification data supplied by the ONU 116. If a match is found, the OLT 112 proceeds to step 220 where it enables the ONU 116 to operate according to its pre-provisioned data and generates an installation status report with a notice that indicates the installation was successful. If a match is not found, the OLT 112 generates an error message included in the installation status report. The error message can be used to point out to the field technician that the ONU 116 was erroneously installed. It can further provide instructions to mitigate the errored installation such as by indicating which ONU 116 should have been installed by vendor ID, model number and/or serial number.

In step 224, the OLT 112 transmits the installation status report to the ONU 116 which in turn transmits it to the butt set 109 in step 226. The butt set 109 presents in step 228 the report audibly utilizing common text to speech technology and/or visually at a user interface (e.g., a display) of the butt set. If the installation was successful, the installation process is completed and in step 230 the technician moves on to the next work order. If the status report indicates the installation was unsuccessful, the technician proceeds to step 232 where s/he uninstalls the ONU 116 and replaces it with another ONU as instructed by the report.

From the foregoing descriptions, it would be evident to an artisan with ordinary skill in the art that the aforementioned embodiments can be modified, reduced, or enhanced without departing from the scope and spirit of the claims described below. For example, method 200 as noted earlier can be applied to the installation of an ONT 117. Similarly, the EMS 110 can perform the functions of the OLT 112 in whole or in part. Additionally, if a power source and ease of access is available to a fiber link at the installation site, the field technician can perform a pre-installation test by temporarily connecting a select ONU 116 or ONT 117 to verify that it is of the correct type. This approach may be helpful to avoid an erroneous full installation. Other suitable modifications can be applied to the present disclosure without departing from the scope of the claims. Accordingly, the reader is directed to the claims for a fuller understanding of the breadth and scope of the present disclosure.

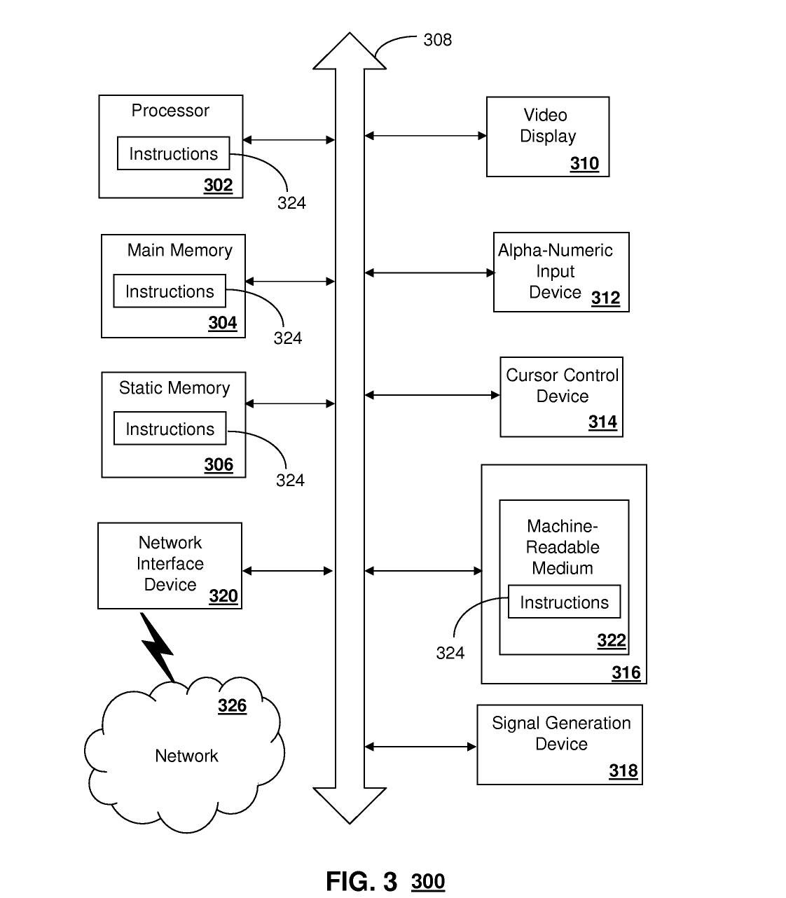

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a mass storage medium 316, a signal generation device 318 (e.g., a speaker or remote control) and a network interface device 320.

The mass storage medium 316 may include a computer-readable storage medium 322 on which is stored one or more sets of instructions (e.g., software 324) embodying any one or more of the methodologies or functions described herein, including those methods illustrated above. The computer-readable storage medium 322 can be an electromechanical medium such as a common disk drive, or a mass storage medium with no moving parts such as Flash or like non-volatile memories. The instructions 324 may also reside, completely or at least partially, within the main memory 304, the static memory 306, and/or within the processor 302 during execution thereof by the computer system 300. The main memory 304 and the processor 302 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the computer-readable storage medium 322 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An optical network device (OND) corresponding to one among an optical network unit (ONU) and an optical network terminal (ONT), comprising a controller element to:
receive a work order from a butt set coupled to the OND;
transmit the work order and identification data to an optical management device (OMD);
receive an installation status report from the OMD based on a comparison of the identification data and validation data retrieved according to the work order; and
transmit the installation status report to the butt set.

2. The OND of claim 1, wherein validation data comprises at least one form of an identification of the OND, and wherein the validation data is generated by an inventory system.

3. The OND of claim 2, wherein the at least one form of identification comprises at least one among a vendor identification, a model number, and a serial number.

4. The OND of claim 1, wherein the identification data comprises at least one among a vendor ID, a model number, and a serial number of the OND.

5. The OND of claim 1, wherein the work order comprises a registration number generated by an ordering system, and wherein the work order is submitted to a field technician to install the OND at a specific site.

6. The OND of claim 1, wherein the OMD comprises one among an optical line terminal (OLT) and an element management system (EMS).

7. The OND of claim 1, wherein the installation status report presents a match or mismatch between the validation data and the identification data.

8. The OND of claim 5, wherein a mismatch indicates the OND has been erroneously installed in a passive optical network (PON).

9. The OND of claim 1, wherein the butt set is coupled to the OND wirelessly or by cable.

10. A computer-readable storage medium, comprising computer instructions for:
receiving a work order and identification data from an optical network device (OND);
retrieving validation data according to the work order;
comparing the validation data with the identification data

11. The storage medium of claim 10, wherein the comparison step determines whether the OND was installed properly in an optical communication network, and wherein the identification and validation data comprise at least one among a vendor ID, a model number, and a serial number of the OND, and wherein the validation data is generated by an inventory system after a supplier has delivered the OND.

12. The storage medium of claim 10, comprising computer instructions for generating an installation status report associated with results from the comparison step.

13. The storage medium of claim 12, comprising computer instructions for transmitting the installation status report to the OND.

14. The storage medium of claim 12, wherein the installation status report presents a match or mismatch between the validation data and the identification data.

15. The storage medium of claim 14, comprising computer instructions for including in the status report an error message responsive to a mismatch, wherein the error message indicates the OND has been erroneously installed in the optical communication network, and provides instructions to mitigate the errored installation.

16. The storage medium of claim 10, wherein the optical communication network corresponds to a passive optical network (PON), wherein the OND comprises one among an optical network unit (ONU) and an optical network terminal (ONT), and wherein the storage medium operates in one among an optical line terminal (OLT) and an element management system (EMS).

17. The storage medium of claim 10, wherein the work order originated from a butt set coupled to the OND.

18. A monitoring device , comprising a controller element to:
transmit a work order to an optical network device (OND) coupled to the monitoring device during an installation of the OND; and
receive an installation status report from the OND responsive to a comparison of identification data of the OND and validation data retrieved according to the work order.

19. The monitoring device of claim 18, wherein the validation data is retrieved and compared to the identification data of the OND by one among an optical line terminal (OLT) and an element management system (EMS) coupled to the OND.

20. The monitoring device of claim 18, wherein the OND comprises one among an optical network unit (ONU) and an optical network terminal (ONT).

21. The monitoring device of claim 18, wherein the monitoring device comprises a butt set coupled to the OND wirelessly or by cable.

22. The monitoring device of claim 18, wherein the controller element presents at least one among a visual and audible presentation of the installation status report by way of a user interface of the monitoring device.
